(19) United States
(12) Patent Application Publication
(10) Pub. No.: US 2010/0190624 A1
(43) Pub. Date: Jul. 29, 2010

(54) PU-ROLL AND METHOD TO PRODUCE SAME

(76) Inventors: Michael Wokurek, Wien (AT); Martin Breineder, Natschbach (AT)

Correspondence Address: TAYLOR & AUST, P.C., P.O. Box 560, 142. S Main Street, Avilla, IN, 46710, US

(21) Appl. No.: 12/718,140

(22) Filed: Mar. 5, 2010

Related U.S. Application Data
(63) Continuation of application No. PCT/EP2008/059792, filed on Jul. 25, 2008.

(30) Foreign Application Priority Data
Sep. 7, 2007 (DE) DE102007042781.8

(51) Int. Cl. F16C 13/00; B28B 1/02; C08K 5/17; C08K 5/18; C08K 5/10

(52) U.S. Cl. 492/53; 264/310; 524/236; 524/240; 524/252; 524/254

(57) ABSTRACT

The present invention relates to a method for producing a roller shell or roller covering of a roller from a PPDI-based polyurethane. To avoid stress cracks, the intention is to overcome the inadequacy in green strength as quickly as possible by the hardener that is added to the polyurethane bringing the pot time down to 5 to 60 seconds. The present invention also relates to a PPDI polyurethane for producing a roller shell or roller covering of a roller formed by mixing a PPDI prepolymer with a hardener, in particular for carrying out the method, wherein 60 to 99% by weight of the hardener is 1,4-butane diol, at most 40% by weight is diamine and at most 1% by weight is a catalyst.

### CROSS REFERENCE TO RELATED APPLICATIONS

This is a continuation of PCT application No. PCT/EP2008/059792, entitled “POLYURETHANE ROLLER AND METHOD FOR THE PRODUCTION THEREOF”, filed Jul. 25, 2008, which is incorporated herein by reference.

### BACKGROUND OF THE INVENTION

1. Field of the Invention

The present invention relates to a p-phenylene diisocyanate (PPDI) polyurethane and a method for manufacturing of a roll sleeve or roll cover for a roll made of a PPDI-based synthetic material.

2. Description of the Related Art

Polyurethane elastomers which are created by a one- or two-stage reaction of PPDI (p-phenylene diisocyanate) with mixtures of polyols, diols and diamines have been known for several decades. PPDI polyurethane elastomers are characterized by high tear resistance and tear propagation resistance, high abrasion resistance, high hydrolytic resistance and high elasticity. However, hardening results in severe shrinkage and poor green strength.

What is needed in the art is a synthetic material and method of producing same so as to reduce the shrinkage and improve the green strength, in order to expand application potentials for the synthetic material.

### SUMMARY OF THE INVENTION

The invention provides a method of producing a synthetic material wherein hardener is added to polyurethane to shorten the pot life to 5 to 60 seconds. As a result of the reduced pot time, the green strength weakness is rapidly overcome, thereby greatly reducing the risk of stress cracks during curing of the synthetic material. The pot time is herein reduced to approximately 8 to 20 seconds, for example, approximately 8 to 12 seconds.

Suitable selection of the hardener allows the reaction speed and the increase in viscosity to be controlled in the course of the cross-linking reaction between the PPDI-based prepolymer and the hardener in such a way that the manufacture of the roll sleeve or roll cover by means of rotary casting becomes feasible. Further, as the result of the accelerated cross-linking reaction, the period of time in which the pot material consistency is solid but lacking in great mechanical strength and elasticity is short.

The synthetic material is applied to a cylindrical, rotatably supported casting body by means of a casting nozzle which is movable parallel to the axis of the casting body, whereby the temperature of the applied synthetic material is, for example, between approximately 70 and 110° C.

To reduce the tendency of the applied synthetic material to form stress cracks during curing, the material contains a catalyst which is selected from a group of PU polymerization catalysts. This group includes various organometallic compounds and salts of Zn, Co, Bi, Hg, Cd, K and many others. Exemplary catalysts include dibutyltin dilaurate, tin octoate, dioctyltin diacetate, dibutyltin mercaptide, dibutyltin oxide, dimethyltin mercaptide, dioctyltin mercaptide, and dimethyltin carboxylate, etc. In addition to any tertiary amine, for example: Bis-(2-dimethylaminoethyl)ether, alkylmorpholine, 1,4-diazabicyclooctane, N,N-alkylbenzylamine, 1,2-dimethylimidazole, N,N-dimethylcyclohexylamine, and N,N,N′,N″-tetramethylethylenediamine.

When casting large hollow cylindrical components such as, for example, press sleeves or roll covers, the circumferential speed of the casting body may, for example, be between approximately 15 and 80 m/min and the casting nozzle may, for example, be axially moved at a speed between approximately 5 and 10 mm/revolution.

To achieve good intermixture of the components, the mixing process with the hardener is in a mixing chamber according to the rotor/stator principle. The rotor and stator are designed to meet a number of conditions. The gap width distribution between the rotor and stator resulting from the design is in the range of approximately 1-5 mm and as narrow as possible in order to achieve the most uniform shear stress possible in the reaction mixture, thereby preventing clogging of the mixture chamber in areas of low shear velocity. Further, the dead volume in the mixing chamber is as small as possible. For example, mixing chambers having a dead volume of approximately 5 to 50 ml for intermixing of a material volume flow of approximately 0.5 to 10 l/min. may be provided.

The resulting short dwell times require very effective intermixing which is achieved on the one hand through high rotor speeds in the range of approximately 1000-5000 rpm, and on the other hand through flow-dividing elements at the rotor and stator which prevent linear flow through the mixing chamber.

With regard to the PPDI polyurethane, the present invention provides that the hardener is composed of approximately 60 to 99 weight % 1,4 butanediol, a maximum of approximately 40 weight % diamine, and a maximum of approximately 1 weight % of a catalyst. By use of such a hardener composition, the desired influencing of the reaction speed and the increase in viscosity in the course of the cross-linking reaction may be achieved. Here, the hardener may contain at least approximately 1 weight % diamine and/or at least approximately 0.01 weight % of a catalyst.

The diamine in the hardener mixture is selected from a group, the group including, for example, diethyltoluenediamine, dimethylthiotoluenediamine, hexamethylenediamine, tetramethylene-diamine, ethylenediamine, o-phenylenediamine, m-phenylenediamine, p-phenylenediamine, 1,4-diaminocyclohexane, 1,2 diaminocyclohexane, 4,4′-diaminodiphenylmethane, isophoronediamine, 4,4′ diaminodicyclohexylmethane, 4,4′-methylene-bis-(3-chloroaniline), 4,4′ methylene-bis-(3-chloro-2,6-diethylaniline), trimethyleneglycoldi-p-aminobenzoate, 1,2-bis-(2-aminophenylthio)ethane, 4,4′-diamino-3,3′-dimethyldicyclohexylmethane.

Further, the PPDI prepolymer may, for example, be selected from a group of products from the Chemtura Company, or an equivalent product from another manufacture, the group including Adiprene LFP 590D, Adiprene LFP 950A, Adiprene LFP 850A, Adiprene LFP 1950A, and Adiprene LFP 2950A. The stoichiometry of the mixture, in other words the molar ratio between the isocyanate content and the content of reactive hydrogen, is between approximately 0.85 and 1.15 to obtain an optimally balanced material characteristics spectrum.

A roll sleeve or roll cover manufactured in this manner is very wear-resistant, capable of bearing high load, and long-lasting, and because of the high demands is suitable for use on rolls in machines for manufacturing and/or processing a paper, cardboard, tissue, or other fibrous material web. The application of the inventive roll sleeve may, for example, be utilized in a soft roll of a calender. The hardness of the PPDI-polyurethane in the roll sleeve is, for example, between approximately 80 Shore A and 75 Shore D. In addition, the loss factor tang of the PPDI-polyurethane in the roll cover is, for example, between approximately 0.01 and 0.03. Because of the low damping, the roll cover is optimized with regard to the maximum possible load pairing of pressure/load frequency. The elasticity module of the PPDI-polyurethane in the roll cover is, for example, between approximately 10 and 3000 N/mm².

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 illustrates a schematic cross section through a casting apparatus according to the present invention.

The exemplification set out herein illustrates one embodiment of the invention and such exemplification is not to be construed as limiting the scope of the invention in any manner.

### DETAILED DESCRIPTION OF THE INVENTION

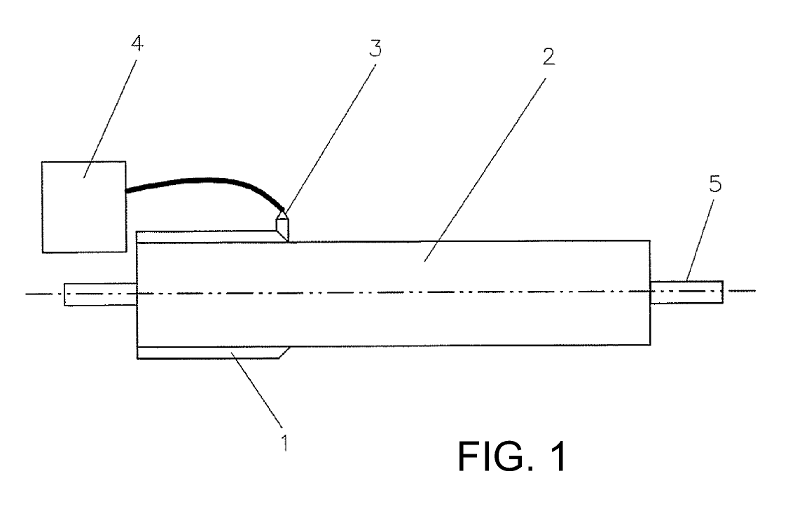

Referring now to the drawing, and more particularly to FIG. 1, there is shown a synthetic material applied in the rotary casting process onto rotatably mounted casting body 2 which is in the embodiment of a cylindrical roll base body for the purpose of forming roll sleeve 1. This occurs by means of casting nozzle 3, designed as a slot die which receives the molten synthetic material at a temperature between approximately 70 and 90° C. from mixing chamber 4. Dynamic mixing chamber 4 operates according to the rotor/stator principle.

During the application process, casting body 2 rotates, for example, at a constant circumferential speed between approximately 15 and 80 m/min. Casting nozzle 3, which is displaceable parallel to rotational axis 5 of casting body 2, is moved at a speed of approximately 2 to 15, for example, between approximately 5 to 10 mm/revolution so that a cover of uniform thickness is applied to casting body 2. The discharge rate of casting nozzle 3 is, for example, between approximately 500 and 10,000 g/min.

To produce roll cover 1 having maximum resistance, the synthetic material is composed of PPDI polyurethane, which is created by mixing a PPDI prepolymer with a hardener in mixing chamber 4. The hardener is intended to shorten the pot life to values between approximately 8 and 12 seconds. Only through this accelerated cross-linking is the utilization of the rotary casting process possible.

This is achieved by using a hardener composed of approximately 65 weight % 1,4-butanediol, approximately 34.95 weight % diethyltoluenediamin and approximately 0.05 weight % dibutyltin laurate.

As the result of its extremely rapid reaction speed, the proportion of diamine determines the flow characteristic of the synthetic material mixture at the point of discharge from casting nozzle 3, and during the first approximately 2 to 5 seconds thereafter. This flow characteristic determines a successful process management. Too low a viscosity results in rapid runoff or castoff of the applied material, depending on the rotational speed and diameter of rotating casting body 2, thereby limiting the achievable layer thickness. Too high a viscosity prevents uniform flow of the synthetic material, resulting in an undesirable coarse surface structure (ribs) and air inclusions. The catalyst subsequently causes the butanediol-isocyanate cross-linking reaction to proceed rapidly. The catalyst is thus responsible for a very brief period of pot material consistency (“cheesy” state/poor green strength) during which the work piece is extremely susceptible to fatal stress cracks.

Only the combined use of both hardener components allows the flow characteristic of the synthetic material mixture necessary for the rotary casting process to be adjusted while also ensuring an end product that is free of stress cracks. The stoichiometry of the mixture is approximately 95% (excess of isocyanate).

This is particularly advantageous in the manufacture of rolls for use in machines for manufacturing and/or processing a paper, cardboard, tissue, or other fibrous material web. Such rolls are exposed to very high stress, and have lengths of up to 10 m and diameters of up to 2 m. The method and the synthetic material are likewise suited for manufacturing flexible roll sleeves. The roll sleeves are usually reinforced by fibers, threads, or the like embedded in the synthetic material, and are used primarily for dewatering or smoothing of the fibrous material web.

The roll sleeves are manufactured in an analogous manner by applying the synthetic material to cylindrical casting body 2, whereby the finished roll sleeve is pulled from casting body 2, or casting body 2 is removed from the cast roll sleeve. Roll covers 1 or roll sleeves manufactured in this manner are characterized advantageously by increased permanent load capacity with regard to line load and machine speed, and extension of possible grinding intervals for machining the sleeve surface.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of manufacturing one of a roll sleeve and a roll cover, the method comprising the steps of:
adding a hardener to a polyurethane to form a p-phenylene diisocyanate (PPDI)-based synthetic material and shorten a pot life to between approximately 5 to 60 seconds; and
forming the one of a roll sleeve and a roll cover from the PPDI-based synthetic material.

2. The method according to claim 1, wherein a pot time is shortened to between approximately 8 to 12 seconds.

3. The method according to claim 2, wherein the method occurs by rotary casting.

4. The method according to claim 3, wherein said synthetic material is applied to a rotatably supported cylindrical casting body by a casting nozzle configured to move parallel to an axis of said casting body.

5. The method according to claim 1, wherein said applied synthetic material has a temperature between approximately 70 to 110° C.

6. The method according to claim 1, wherein said hardener includes a catalyst, said catalyst being a polyurethane polymerization catalyst formed from one of organometallic compounds, salts and tertiary amines.

7. The method according to claim 6, wherein a circumferential speed of said casting body is between approximately 15 to 80 m/min.

8. The method according to claim 7, wherein said casting nozzle is axially moved at a speed between approximately 2 to 15 mm/revolution.

9. The method according to claim 8, wherein said casting nozzle is axially moved at a speed between approximately 5 to 10 mm/revolution.

10. The method according to claim 1, wherein said mixing of said hardener occurs in a mixing chamber according to the rotor/stator principle.

11. A p-phenylene diisocyanate (PPDI) polyurethane for the production of one of a roll shell and roll cover for a roll, the PPDI-based synthetic material including:
a mixture of a PPDI-prepolymer and a hardener, the hardener including between approximately 60 to 99 weight % 1,4 butanediol, a maximum weight % of approximately 40 weight % diamine and a maximum of approximately 1 weight % of a catalyst.

12. The PPDI polyurethane according to claim 11, wherein said hardener includes at least 1 weight % diamine.

13. The PPDI polyurethane according to claim 12, wherein said hardener includes at least approximately 0.01 weight % of said catalyst.

14. The PPDI polyurethane according to claim 12, wherein said diamine is from one of diethyltoluenediamine, dimethylthiotoluenediamine, hexamethylenediamine, tetramethylenediamine, ethylenediamine, o-phenylenediamine, m-phenylenediamine, p-phenylenediamine, 1,4-diaminocyclohexane, 1,2-diaminocyclohexane, 4,4′-diaminodiphenylmethane, isophoronediamine, 4,4′ diaminodicyclohexylmethane, 4,4′-methylene-bis-(3-chloroaniline), 4,4′ methylene-bis-(3-chloro-2,6-diethylaniline), trimethyleneglycoldi-p-aminobenzoate, 1,2-bis-(2-aminophenylthio)ethane, and 4,4′-diamino-3,3′-dimethyldicyclohexylmethane.

15. The PPDI polyurethane according to claim 14, wherein said catalyst is from a group of polyurethane (PU) polymerization catalysts formed of one of organometallic compounds, salts and tertiary amines.

16. The PPDI-polyurethane according to claim 15, wherein a mixing ratio between said prepolymer and said hardener corresponds to approximately 85% to 115% stochiometry.

17. The PPDI-polyurethane according to claim 16, wherein the PPDI-polyurethane has a hardness between approximately 80 Shore A to 75 Shore D.

18. A roll, comprising:
a roll core; and
a roll cover at least partially surrounding a surface area of said roll core, wherein said roll cover includes a PPDI-polyurethane synthetic material, said PPDI-polyurethane including a mixture of a hardener and a polyurethane.

19. The roll according to claim 18, wherein said PPDI-polyurethane in said roll cover has a hardness of between approximately 80 Shore A to 75 Shore D.

20. The roll according to claim 19, wherein a loss factor (tang) of said PPDI-polyurethane in said roll cover is between approximately 0.01 to 0.03.

21. The roll according to claim 20, wherein an elasticity module of said PPDI-polyurethane synthetic material in said roll cover is between approximately 10 to 3000 N/mm².

22. The roll according to claim 21, wherein the roll is configured for use in a machine for one of the manufacture and processing one of a fibrous web, paper, tissue and cardboard.

23. The roll according to claim 22, wherein said roll is configured as a soft roll in a calender.
